(19) United States
(12) Patent Application Publication
(10) Pub. No.: US 2020/0314190 A1
(43) Pub. Date: Oct. 1, 2020

(54) DE TERMINING THAT MULTIPLE REQUESTS ARE RECEIVED FROM A PARTICULAR USER DEVICE

(71) Applicant: CLOUDIQ LIMITED, London (GB)

(72) Inventor: PAUL SAMUEL PHILLIPS, LONDON (GB)

(73) Assignee: CLOUDIQ LIMITED, London (GB)

(21) Appl. No.: 16/498,942

(22) PCT Filed: Mar. 29, 2018
(86) PCT No.: PCT/GB2018/050898

§ 371 Date: Sep. 27, 2019

(30) Foreign Application Priority Data
Mar. 29, 2017 (GB) 1705060.0

(51) Int. Cl. H04L 29/08; H04L 29/12

(52) U.S. Cl. CPC H04L 67/146; H04L 61/35; H04L 67/02

(57) ABSTRACT

A method comprising: receiving (300) at a server means (100; 101) a first request from a user device (102), the request including a first uniform resource locator (URL) and storing the first URL; receiving (306) a second request from the user device, including a second URL and first information indicative of the first URL; determining (308), by matching the first information and the stored first URL, that the first request and the second request were sent from the user device; storing the second URL in association with the first URL, so that a third request including second information indicative of the second URL can be matched to the second URL. The first, second and third requests may be HTTP requests.

### FIELD OF THE INVENTION

The invention relates to a method of determining that requests received at a server means are sent from a same device, where the server means receives requests from multiple devices. The invention also relates to related apparatus and a computer program product.

### BACKGROUND

In an environment in which a server receives requests from multiple client applications using a stateless protocol, it is often wanted to configure the server to determine which requests are received from each client application. Thus, when the server receives a first request from a particular client application, the server initiates a session, assigns a unique session identifier to the session, and sends the session identifier to the client application. Then, each time that the client application sends a request to the server, the client application includes the session identifier so that the server can associate the requests from that client application. The server may store session data in association with the session identifier. Particular session data is thus associated with a particular client application.

Session identifiers are commonly used by web servers. When a client application in the form of a web browser receives a session identifier, the web browser stores the session identifier as part of a cookie. The cookie also includes the domain of the web server. When the web browser next sends an HTTP request to the same domain, the web browser identifies the stored cookie using the domain and includes the session identifier with the HTTP request.

A major problem with the above described approach is that some web browsers are prevented from storing cookies and thus cannot store session identifiers. Accordingly, session identifiers cannot be sent with requests by such web browsers to the server and so later requests cannot be reconciled with earlier ones. It is an object of the present invention to address this problem.

### SUMMARY OF THE INVENTION

In accordance with a first aspect of the present invention, there is provided a method comprising: receiving at a server means a first request from a user device, the request including a first uniform resource locator (URL), and storing the first URL; receiving a second request from the user device, including a second URL and first information indicative of the first URL; determining, by matching the first information and the stored first URL, that the first request and the second request were sent from the user device; storing the second URL, so that a third request including second information indicative of the second URL can be matched to the second URL.

In accordance with a second aspect of the present invention, there is provided a computer program product comprising computer program code stored on a computer readable storage medium, which, when executed by a processing means, causes the following steps to be performed: receiving at a server means a first request from a user device, the request including a first uniform resource locator (URL), and storing the first URL; receiving a second request from the user device, including a second URL and first information indicative of the first URL; determining, by matching the first information and the stored first URL, that the first request and the second request were sent from the user device; storing the second URL, so that a third request including second information indicative of the second URL can be matched to the second URL.

In accordance with a third aspect of the present invention, there is provided apparatus comprising: a processing means; and a memory means having a computer program stored thereon, wherein the computer program comprises computer program code, wherein the processing means, together with the memory means and the computer program code, are configured to perform steps of: receiving at a server means a first request from a user device, the request including a first uniform resource locator (URL), and storing the first URL; receiving a second request from the user device, including a second URL and first information indicative of the first URL; determining, by matching the first information and the stored first URL, that the first request and the second request were sent from the user device; storing the second URL, so that a third request including second information indicative of the second URL can be matched to the second URL.

### BRIEF DESCRIPTION OF THE FIGURES

For better understanding of the present invention, embodiments will now be described, by way of example only, with reference to the accompanying Figures in which:

FIG. 1 shows illustratively an environment in which embodiments of the invention may be implemented;

FIG. 2 is a flow diagram indicating processes that may be used in combination to reconcile requests received at a server with particular sessions;

FIG. 3 is a flow diagram indicating steps of one process (“daisy chain process”) for reconciling received requests, in accordance with embodiments of the invention;

FIG. 4 is flow diagram indicating steps in accordance with a process (“cookie based process”) for reconciling received requests using session identifiers;

FIG. 5 is a flow diagram indicating a further process (“fingerprinting process”) for reconciling received requests;

FIG. 6 is a flow diagram indicating use of the daisy chain process in reconciling requests received at a data collection server with previously received requests.

### DETAILED DESCRIPTION OF EMBODIMENTS

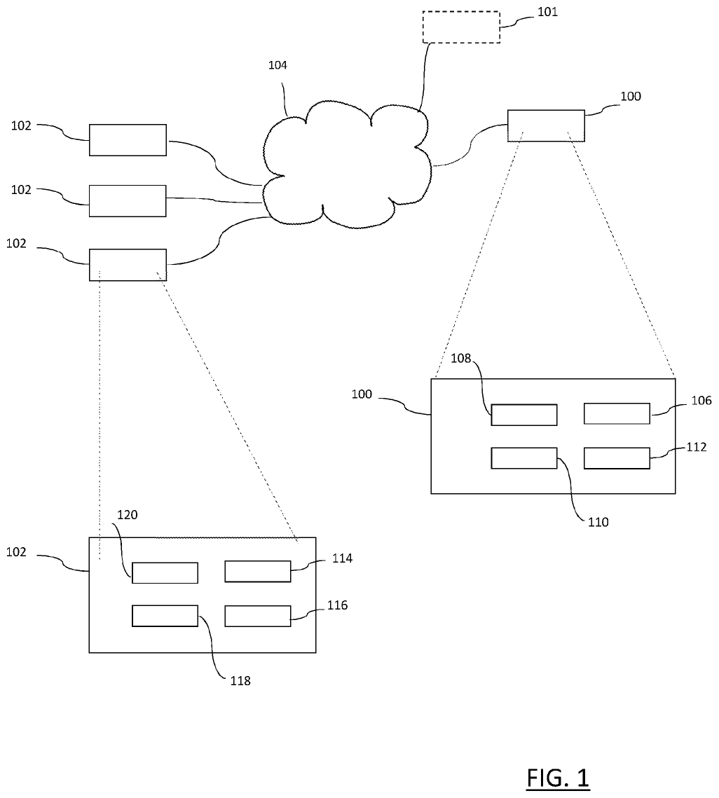

Referring to FIG. 1, an environment is indicated in which embodiments of the invention may be implemented. A server 100 is configured for communication with a plurality of user devices 102 via a communications network 104. Although three user devices are shown, there are typically many more.

Generally, a website, stored at the server 100, has several webpages. The server 100 is configured to receive requests for webpages from any of the user devices and to send the webpages to the user devices 102 in response to the requests. Each of the webpages, when rendered by a web browser at the particular user device 102, typically has embedded uniform resource locators (URL) in it identifying respective other of the webpages. A user is able to operate the user device 102 to select links on the webpages resulting in use of the URLs to conveniently browse the web site using the web browser. Selecting a link causes a Hypertext Transfer Protocol (HTTP) request to be sent by the web browser to the server 100. The server 100 responds to the request by sending webpage data from which the requested webpage can be rendered to the user device 102.

The webpage request includes a “destination URL”, which identifies the webpage that is requested from the web server and with which the webpage request is routed to the server 100 over the Internet. When the user selects a link on a webpage, the webpage request also includes, not only the destination URL, but also the URL of the webpage on which the link was selected, which is the “referrer URL”.

Embodiments of the invention relate to determining that multiple requests received at the server 100 are from the same user device, where the server 100 may receive requests for webpages from many user devices. This is particularly useful where data is stored by the server 100 relating to interaction between the server 100 and the user device. The determining is achieved, in accordance with embodiments, by storing destination URLs of received requests, and then, when a new request is received, matching the referrer URL of the newly received request to one of the stored destination URLs.

Also, where it is wanted to collect information relating to user interactions with a webpage or events on the webpage, tracking requests may be sent including information on the user interaction or event to another server for example for analytics purposes. Such tracking requests may, in accordance with embodiments, include the current URL of the web page, so that the current URL can be matched against a stored URL of an earlier request. It is envisaged to carry out this process in combination with other processes, to be described.

Importantly, embodiments of the invention are not limited to use with web browsers, websites and HTTP requests. Embodiments may be usefully applied in any scenario where requests are sent using a stateless protocol, an online resource has a plurality of parts that may be requested by and sent to a user device, and where parts are requested consecutively, with requests including a destination URL or equivalent, that are stored by the server, and including a referrer URL or equivalent, other than a first request.

The server 100 stores information relating to visits by users to the website. Each user device 102 has a client application in the form of a web browser running on it. Each user device 102 and the server 100 are configured to communicate via the communications network 104 using HTTP/S. The term “request” as used in relation to the embodiments described below should be considered to mean HTTP request, although the invention is not limited to such as mentioned above.

Embodiments are described in the following with reference to a single user device 102. When the server 100 receives a first request from the user device 102 relating to a particular website, the server 100 initiates a session and generates a session identifier, which is stored in a session data store. The server 100 may determine that the received request is a first request relating to the website when the referrer URL of the first request indicates a domain other than that of the website, or is empty, or if the request cannot be matched using any one or more of the processes described herein, depending on a particular embodiment.

Data associated with the session can then be usefully stored in association with the session identifier in the session data store. The server 100 may be configured so that the sessions have a maximum predetermined length, or so that each session expires if there has been an absence of requests associated with the session identifier for that session for a predetermined time period.

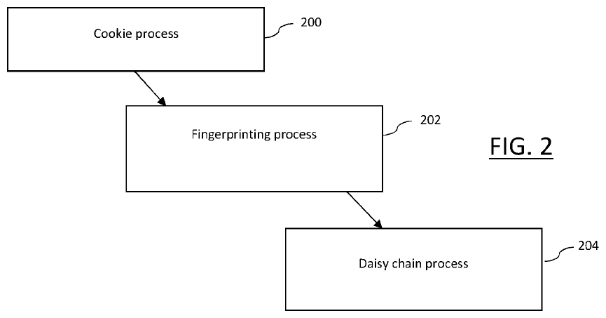

Referring to FIG. 2, one or more processes may be used to reconcile requests received at the server 100. Three such processes are described herein, which are referred to as a “cookie” based process 200, a “fingerprinting” process 202, and a “daisy chain” process 204. Use of the cookie based process in isolation is already known for determining that received requests relate to a particular, previously initiated session and is mentioned above. The cookie based process may often be used to successfully reconcile a majority of received requests with sessions that have been initiated in response to first requests sent to the server 100 from respective user devices. Where a received request is not found to relate to a previously established session using the cookie based process, the fingerprinting process may then be used to try to match the received request with a session identifier.

In embodiments, if a received request does not match to a previously established session after the fingerprinting process has been performed, the daisy chain process is then run. If the daisy chain process fails to match a received request to a previously established session, a new session is initiated and a session identifier is generated and stored in the session data store.

Use of these three processes in combination results in a high probability that, if a session has been initiated, the corresponding session identifier will be identified for any received request. Nevertheless, the daisy chain process may be carried out independently of either the cookie based process and the fingerprinting process. Alternatively, the daisy chain process may be carried out following one of the cookie based process or the fingerprinting process, where the other is not used for session reconciliation.

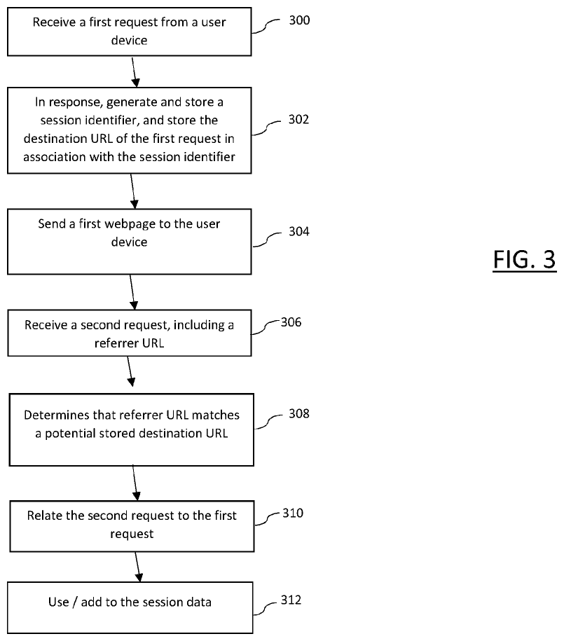

The daisy chain process is described first in isolation with reference to FIG. 3 when used to reconcile received requests. At step 300, the server 100 receives a first request from the user device 102, the first request including a destination URL. The request does not derive from selecting a link on a webpage of the website, but from selection of a link on another web site or entering of an address of the webpage. In response, the server 100 generates a session identifier and stores the session identifier in the session data store at step 302. The server 100 also sends the requested webpage to the user device 102 at step 304. The server 100 also stores the destination URL in association with the session identifier.

Next, the user selects a link for another webpage on the received webpage, thereby causing the user device 102 to send a second request to the server 100, the second request also including a destination URL of the other webpage and the referrer URL, which is the destination URL in the first request. The server 100 receives the second request at step 306.

In response to the second request, the server 100 determines whether the second request is from a user device for which a session has already been established. To do this, the server 100 scans at step 308 candidate stored destination URLs associated with current session identifiers to determine whether any destination URL is the same as the referrer URL in the second request. The server 100 is configured so that the candidate stored destination URLs that are scanned are only the destination URLs received in the most recently received request relating to a session.

If at step 308 the server 100 identifies a matching destination URL, then at step 310, the server 100 determines that the second request relates to the session identified by the session identifier with which the matching destination URL is associated. The server 100 may then use session data stored for the session in response to the second request and/or store further session data in response to the second request, as indicated at step 312.

The server 100 also stores the destination URL of the second request in association with the session identifier, and updates so that the destination URL in the second request is stored as the most recently received destination URL relating to the session. In response to the second request, the server 100 sends a second webpage to the user device, the webpage including an URL of a third webpage. If the user operates the web browser to send a third request with the URL of the third webpage as the destination URL and the URL of the second webpage as the referrer URL, the daisy chain process can be used to match the third request to the session in the same way that the second request was matched to the session, that is, by matching the referrer URL to a destination URL of the second request stored at the server 100. Each further request from the user device 102 for webpages of the website that includes a destination URL and a referrer URL, the referrer URL also identifying a page of the same website, may be matched to the session identifier using the same process, that is, by matching the referrer URL with the destination URL of the previous request relating to the session.

As mentioned above, the daisy chain process may be used alone and would work well in reconciling received requests where the number of received requests is low and/or where the session has a short expiry time. However, it is envisaged that the process is used in combination with the other processes for determining that received requests have originated from the same user device 102. Accordingly, in a preferred embodiment, first the cookie based process is attempted in which the session identifier is used to enable the server 100 to match received requests to a particular session.

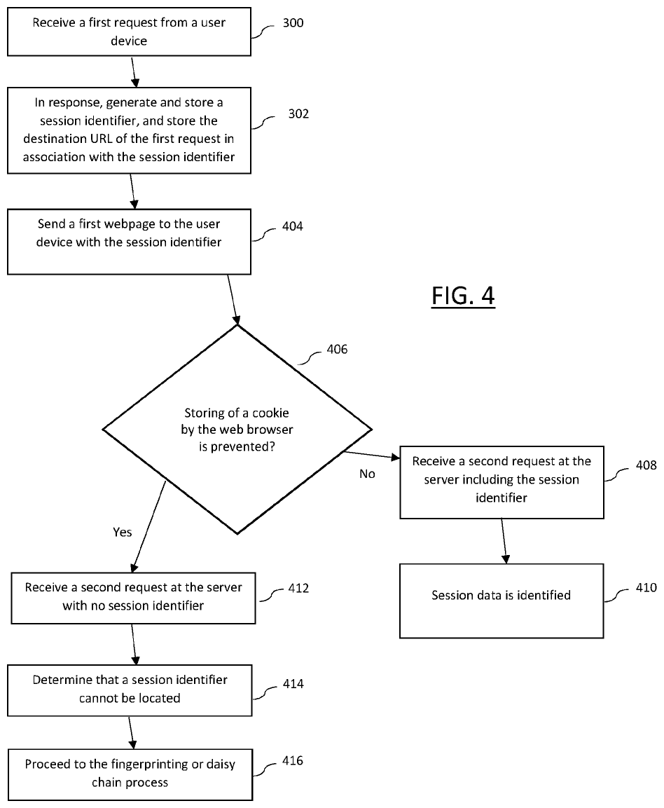

Referring to FIG. 4, first and second steps are the same as steps 300 and 302. At step 404, the server 100 sends the requested first webpage to the user device 102, like at step 304, together with a cookie comprising at least the session identifier and the domain of the web site. The cookie may be a session cookie.

As indicated at step 406, the user device 102 may not receive the cookie or the web browser may receive the cookie but be prevented from storing it. If the web browser receives and stores the cookie, the web browser can then include the session identifier with the second request to the server 100. In this case, the server 100 receives the second request, as indicated at step 408, and is able to associate the received second request with the session data (step 410). The server 100 can then respond to the second request using the session data, and/or can change the session data.

If the cookie is prevented from being stored at the user device 100, the second request is received at the server 100 without a session identifier at step 412. The server 100 determines that a session identifier cannot be located at step 414.

In this case, at step 416 one of the daisy chain process and the fingerprinting process is performed next, in accordance with different embodiments.

The fingerprinting process serves to match the second request with a first request, or at least to determine a number of potential first requests received from multiple user devices with which the second request may be associated, that number being less than the total number of session identifiers relating to unexpired sessions.

Exemplary use of the fingerprinting process is now described, where a request is received at the server 100 that is a first request from the user device 102, that is, a request not deriving from selection of a link on a webpage of the website hosted by the server 100.

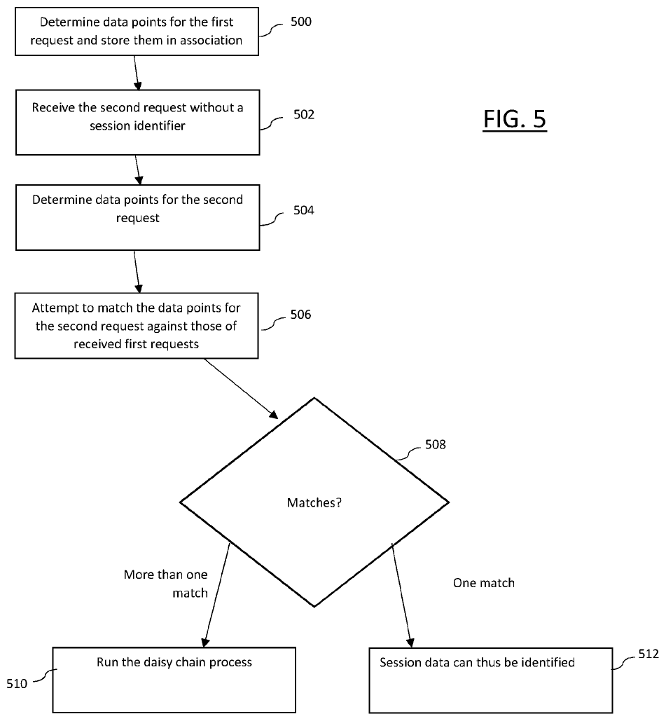

The server 100 receives a request and the cookie-based process is not used or the request cannot be matched with a session, so the server 100 determines a fingerprint of the request. Referring to FIG. 5, the fingerprinting is done, as indicated at step 500, by determining a plurality of data points for the request, which together provide a fingerprint or identification of the user device 102. Each of the data points may be one of the following:
a session start time;
a user agent of the web browser from which the request is sent;
an IP address of the user device from which the request is sent;
information identifying a screen resolution of the user device from which the request is sent;
a screen colour depth of the user device from which the request is sent;
a browser language of the web browser from which the request is sent;
a time zone offset of the web browser from which the request is sent;
MIME types supported by the web from which the request is sent;
A plugin profile of the web browser from which the request is sent;
A canvas profile associated with the user device from which the request is sent;
Local storage profiling associated with the user device from which the request is sent.

Not all of these data points need be determined or extracted from the request—a few of these data points may serve as a fingerprint for the user device 102 from which the request was sent. Data points other than those listed may additionally or alternatively be determined. The server 100 attempts to match the determined fingerprint against fingerprints corresponding to current sessions, but since the request is a first request and no fingerprint is stored, the server 100 fails to do so. Thus, a new session is establishes with a new session identifier.

At step 502, a second request is received. Where the cookie based process is implemented, the server 100 then attempts to locate a session identifier the second request, but there is not session identifier and so cannot (that is, step 412 and 414 occur). Thus, the cookie based process cannot be used. At step 504, the same data points are extracted from the second request. Those data points are then stored and compared at step 506 with data points stored for the first requests for current sessions.

If the server 100 determines at step 508 that the data points extracted from the request match those extracted from one first request, indicated at step 512, the server 100 then determines that the second request relates to the same session as the matched first request. Session data associated with the session identifier for the matched first request can then be identified and may be added to and/or used.

If the server 100 determines at step 508 that the data points of the received request match to at least two sets of data points corresponding to first requests from at least two user devices 102, in embodiments the server 100 is configured to perform the daisy chain process to determine which, if any, of those first requests come from the same user device as the second request.

In an example scenarios in which embodiments of the invention may be implemented. in response to a first request sent to the server 100, the server sends to the user device 102 a webpage including an online form in response to a first request. The form has a form identifier with it. The form identifier is stored as session data. The user then enters data into the online form and selects an URL to send the entered data to the server 100 with a second request. The server 100 then uses the above described processes to associate the second request with the session identifier, and then stores the entered data as session data in association with the session identifier and the form identifier. Forms may be on multiple pages and the data entered by the users is associating using the session identifier using the above described processes.

In another example, a user may send a first request to the server 100, which in this case hosts a shopping website, and receive a first webpage. The user may then interact with the webpage, involving sending a second request to the server 100 indicating that a particular item is to be added to an online shopping cart. Information indicative of this is then added to the session data. The user may then selects a URL such that a request is sent for a webpage enabling payment. It is essential that the request for this webpage is associated with the previous requests, otherwise, as far as the user is concerned, the contents of the online cart will be lost.

In another embodiment, a data collection server 101 is also connected to the communications network 104. The data collection server 101 is indicated using dashed lines in FIG. 1 as it is not part of the embodiment as described above in relation to FIG. 1. In this embodiment, the server 100 still sends webpages to any of the user devices 102 on receipt of requests from the user devices 102, and may operate as described above using any one or more of the cookie based process, the fingerprinting process and the daisy chain process. The server 100 may alternatively match requests received from user devices 102 using other methods or not match received requests. However, in this embodiment, each webpage includes a portion of tracking code that is executed by the web browser each time a predetermined interaction or event occurs on the webpages, or alternatively that executes to pull some code to the web browser, that pulled code being executed each time a predetermined interaction or event occurs. The tracking code is typically JavaScript and the web browser includes a JavaScript engine for executing the JavaScript. The result is that a tracking request is sent to the data collection server 101 each time the predetermined interaction or event occurs. The predetermined interaction may be interaction by a cursor with an HTML element.

It is known for the JavaScript to include a cookie. Conventionally, the cookie is sent with tracking requests sent to the data collection server 101. If the network, computer or web browser does not allow this, the same problem of matching tracking requests occurs at the data collection server 101 as may occur at the web server 100, as described above.

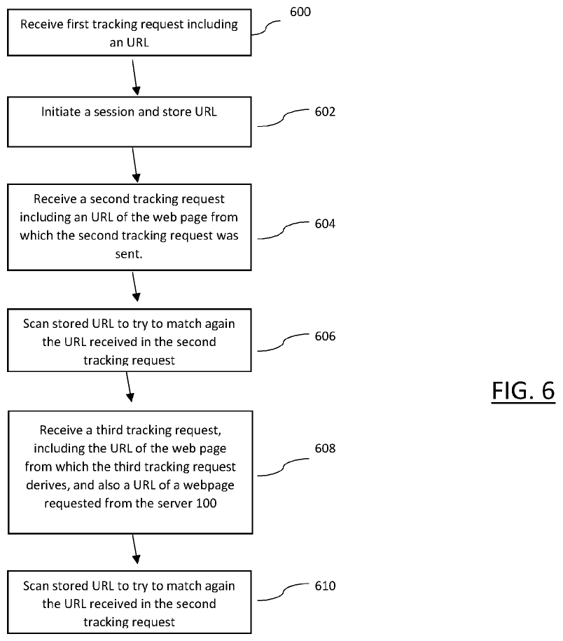

A method of reconciling received requests at the data collection server 101 will now be described with reference to FIG. 6. A request for a webpage, including a destination URL of the requested webpage, is sent from the user device 102 and is received at the server 100, as at step 300. In response, the server 100 sends the requested webpage to the user device 102.

The JavaScript executes to cause data collection to begin. The JavaScript causes the web browser to send a first tracking request to the data collection server 101, which is received at step 600. The first tracking request includes the URL of the received webpage.

The server 100 may have sent a cookie with the webpage to the user device 102 and, if such a cookie was sent, the user device 102 may have received it and the web browser stored it. In this case, the JavaScript reads the cookie and sends a copy of the cookie to the tracking server 101 with the first tracking request. Provided future tracking requests sent from the user device 102 to the data collection server 101 include a copy of the cookie, the cookie-based process can be used to reconcile the received tracking requests. Where the cookie-based process cannot be used or fails, the fingerprinting process can be used. The daisy chaining process may be used where either these processes fail or are not used, as described above, although the daisy chain process may also be used independently.

At step 602, in response to receiving the first tracking request, the data collection server 101 determines whether the first tracking request matches to any session. This may be done using any of the processes described above to try to match the first tracking request to a session. Since this is a first tracking request, a session has not been established, so the data collection server 101 will not be able to identify a session. The data collection server 101 thus initiates a session, generates a session identifier for the session, and stores the URL of the webpage in association with the session identifier. Other data may be stored in association with the session identifier.

When the user operates the user device 102 to interact with the webpage, the JavaScript causes sending of a second tracking request including information relating to the interaction to the data collection server 101, together with the URL of the webpage. The interaction may relate, for example, to any of a number of interactions for which data may be collected.

The second tracking request includes a copy of the URL of the current webpage. Where the daisy chain process is used, at step 604, the data collection server 101 receives the second tracking request and scans the URLs stored in association with current session identifiers against the URL received in the second tracking request. If one such URL matches the URL in the tracking request, the data collection server 101, at step 606, determines the session identifier and thus the session data for the session identifier, which is then updated to include the information relating to the interaction.

The user may also operate the user device 102 to select a link on the webpage, which causes a request including a second destination URL to be sent to the server 100. In addition to this second request being sent to the server 100, selecting of the link causes the JavaScript to cause a third tracking request to be sent to the data collection server 101. The third tracking request includes the referrer URL, that is, the URL of the webpage on which the link was selected, and the destination URL, that is, the URL of the new webpage. At step 608, the data collection server 101 receives the third tracking request and then scans potentially relevant URLs stored with current sessions to try to match the referrer URL with one of the stored URLs. If one such URL matches the referrer URL, the data collection server 101, at step 610, determines the session identifier and thus the session data for the session identifier associated with that referrer URL. The potentially relevant URLs are those where is then updated to include the new destination URL and optionally other data.

The second tracking request is an example of a tracking request that includes the current URL of the webpage. The daisy chain process works by matching the current URL with a stored URL that is associated with a session identifier. Many such second tracking requests may be sent from the user device 102 to the data collection server 101 and matched in this way. The second tracking request may have fields corresponding to a referrer URL and a destination URL, in which case both may be populated with the URL of the current webpage. Such a second tracking request is sent in response to a predetermined interaction other than selection of link to request a new webpage. As well as being sent in response to predetermined user interactions, such request may be send in response to other predetermined events, as is well known to persons skilled in the art.

The third tracking request is an example of a tracking request typically including fields corresponding to a referrer URL and a destination URL, where the fields are populated with different URLs. This occurs when the user has selected a link resulting in a new webpage being requested. In this case, the daisy chain process works by matching the old URL (in the referrer URL) with a stored URL that is associated with session identifiers. Many such third tracking requests may be sent from the user device 102 to the data collection server 101 and the old URL matched to the URL of the previous webpage, with the URL of the new webpage being stored.

The daisy chain process works particularly well where the cookie based process and/or the finger printing is attempted beforehand. Where the cookie based process is attempted, the scanning of the URLs in the daisy chain process may include scanning to establish where a cookie has previously been associated with a particular session identifier. If it has, the destination URL associated with that session identifier need not be scanned.

Similarly, where the fingerprinting process has previously been successfully used at reconciling requests from a user device, the URL associated with the session identifier corresponding to that user device need not be scanned in the daisy chain process. In this way, when the daisy chain process is used, a large proportion of session identifiers need not be scanned, which means that the likelihood of the daisy chain process being successful at matching a received request with a previously established session is high. For example, 80% of requests received at the data collection server may be matched against the relevant session identifier using the cookie based process. A further 15% may be matched using the fingerprinting process. Almost 5% that cannot be matched using these processes may then be matched using the daisy chain process. Thus, the scanned URLs in the daisy process may only scan a subset of the total number of URLs if the fingerprint process and/or the cookie based process has been tried and some of the current sessions eliminated as possible sessions. It should be possible to correctly match almost all tracking requests received at the data collection server using the three processes in combination.

The data collected by the data collection server 100 may be usefully used. For example, where the data includes identifiers of the contents of an online shopping cart and also an email address of the user of a user device 102 is known, for example because the user has submitted it on a previous webpage, emails can be sent to the email address prompting the user to complete the purchase.

Both when reconciling received requests at the server 100 and the data collection server 101, it should be understood that the cookie-based process and/or the fingerprinting process may be used to usefully reduce the number of potentially relevant/candidate stored URLs for matching in the daisy chain process, so that the likelihood of a received URL being matched against a single one of the potentially relevant stored URLs is high. The potentially relevant stored URLs include only those URLs that, in the most recently received requests relating to a session, were indicated as corresponding to the most recently requested webpage of the user. The daisy chain process may be implemented with other processes for reconciling received requests besides a cookie based process and/or the fingerprinting process. Other techniques are preferably implemented to reduce the number of potentially relevant stored URLs. For example, sessions may have related timers and expire after a predetermined period during which no requests were received related to the session. In this case, after expiry, no URL related to that session is potentially relevant. Further, if the cookie based process has previously been successfully used to associate a request with a session, it can be assumed that the cookie based process will work in relation to future requests relating to the same session, so any URL received in requests relating to that session can be excluded as a potentially relevant URL.

Returning to FIG. 1, the communications network 104 may be the internet. The communications network 104 may comprise a plurality of connected networks. For example, communication may be via the internet to which the server 100 is connected and a local area network or a cellular telecommunications network to which the user device 102 is connected.

Components of the server 100 includes a processor 106, for example a CPU, a memory 108, a network interface 110 and input/output ports 112, all operatively connected by a system bus (not shown). The memory may comprise volatile and non-volatile memory, removable and non-removable media configured for storage of information, such as RAM, ROM, Erasable Programmable Read Only Memory (EPROM), Electrically Erasable Programmable Read Only Memory (EEPROM), flash memory or other solid state memory, CD-ROM, DVD, or other optical storage, magnetic disk storage, magnetic tape or other magnetic storage devices, or any other medium which can be used to store information which can be accessed. The processor may comprise a plurality of linked processors. The memory may comprise a plurality of linked memories. Other components may also be present.

A computer program comprising computer program code is provided stored on the memory 108, The computer program, when run on the processor 106, is configured to provide the functionality ascribed to the server 100 herein. In particular, the computer program provides web server functionality. As will be understood by the skilled person, the server 100 would in practice include many more components.

The data collection server 101 typically includes same or similar components to the server 100. Similarly, a computer program comprising computer program code is provided stored on a memory at the data collection server 101, The computer program, when run on a processor, is configured to provide the functionality ascribed to the server 101 herein.

Each user device 102 may be a personal computer, laptop, smartphone, tablet, for example. Each user device 102 comprises a processor 120, a memory 114, input/output ports 116, a transceiver 118 and a user interface (not indicated). As will be understood by the skilled person, the user device 102 would in practice include many more components. A computer program, such as a web browser, comprising computer program code is provided stored on the memory 114. The computer program, when run on the processor 120, is configured to provide some of the functionality ascribed to the user device herein. The interface may comprise a display, keyboard and mouse, but alternatively the interface may comprise a voice operated interface.

It will be appreciated by persons skilled in the art that various modifications are possible to the embodiments.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method comprising:
receiving at a server means a first request from a user device, the request including a first uniform resource locator (URL), and storing the first URL;
receiving a second request from the user device, including a second URL and the first URL;
determining, by matching the first URL received in the second request and the stored first URL, that the first request and the second request were sent from the user device;
storing the second URL, so that a third request including the second URL can be matched to the stored second URL.

2. The method of claim 1, further comprising:
in response to the first request, generating and storing at the server means a session identifier, wherein the storing of the first URL is in association with the session identifier.

3. The method of claim 2, wherein the first request includes first data, the method further comprising storing the first data in association with the session identifier.

4. The method of claim 3, wherein the determining comprises associating the second request with the session identifier.

5. (canceled)

6. The method of claim 1, further comprising:
in response to receiving the second request, determining that the session identifier cannot be located in the second request, and then performing the determining, by matching the first URL received in the second request and the stored first URL, that the first request and the second request were sent from the user device.

7. The method of claim 1, wherein the first and second requests each have associated therewith a set of data points, further comprising:
further to receiving the first request, determining and storing, by the server means, the set of data points of the first request;
further to receiving the second request, determining the data points of the second request and comparing the data points of the second request against stored sets of data points deriving from a plurality of requests received at the server means from a plurality of user devices, wherein the received requests include the first request,
determining that the data points of the second request match to the stored data points of at least two of the plurality of received requests, the at least two received requests including the first request, wherein the determining, by matching the first URL received in the second request and the stored first URL, includes scanning stored first URLs associated with the at least two requests to identify the first URL.

8. The method of claim 1, further comprising:
receiving a third request from the user device, including the second URL;
determining, by matching the second URL received in the third request and the stored second URL, that the second request and the third request were sent from the user device.

9. The method of claim 8, further comprising:
in response to receiving the third request, determining that the session identifier cannot be located in the third request, and then performing the determining, by matching the first URL received in the second request and the stored first URL, that the first request and the second request were sent from the user device.

10. (canceled)

11. The method of claim 1, wherein the first, second and third requests are HTTP or HTTP based requests and the user device has a web browser running thereon, wherein the second request includes the first URL in a referrer field thereof and the second URL in a destination field thereof, and wherein the third request includes the second URL in a referrer field thereof.

12. (canceled)

13. The method of claim 1, wherein the first and second URLs correspond to webpages, the method further comprising, in response to the receiving of the first request, sending first webpage data requested in the first request, including the second URL, to the user device, wherein the second request is received in response to operation of the user device to select the second URL.

14. The method of claim 1, further comprising, in response to the receiving of the second request, sending second webpage data requested in the second request, including the third URL, to the user device, wherein the third request is received in response to operation of the user device to select the third URL.

15. The method of claim 1, wherein the first request is sent from the user device in response to the user operating the user device to cause a webpage request for a webpage corresponding to the first URL to be sent to a further server means, wherein the first request is a first tracking request;
wherein the second request is sent from the user device in response to a user operating the user device to cause a webpage request for a webpage corresponding to the second URL to be sent to the further server means, wherein the second request is a second tracking request.

16. The method of claim 15, further comprising:
after receiving the first tracking request and storing the first URL, and before receiving the second tracking request, receiving a further tracking request deriving from a predetermined event or interaction relating to a web browser running on the user device, wherein the further tracking request is not sent in response to the user operating the user device to cause a webpage request to be sent to the further server means, wherein the further tracking request includes the first URL;
determining, by matching the first URL received in the further tracking request and the stored first URL, that the first tracking request and the further tracking request were sent from the user device.

17. The method of claim 15, wherein the third request is sent from the user device in response to a user operating the user device to cause a webpage request for a webpage corresponding to the third URL to be sent to the further server means, wherein the third request is a third tracking request.

18. The method of claim 15, wherein the third request is a yet further tracking request, the yet further tracking request deriving from a predetermined event or interaction relating to a web browser running on the user device, wherein the yet further tracking request is not sent in response to the user operating the user device to cause a webpage request to be sent to the further server means, wherein the yet further tracking request includes the second URL;
determining, by matching the second URL received in the yet further tracking request and the stored second URL, that the second tracking request and the yet further tracking request were sent from the user device.

19. The method of claim 16, further comprising:
in response to receiving the further tracking request, determining that a session identifier cannot be located in the further tracking request and then performing the determining, by matching the first URL received in the second request and the stored first URL, that the first request and the second request were sent from the user device.

20. The method of claim 15, wherein the further tracking request includes a set of data points, further comprising:
further to the receiving of the further tracking request, comparing the data points of the further tracking request against the stored sets of data points deriving from a plurality of requests received at the server means from a plurality of user devices, wherein the received requests include the first tracking request,
determining that the data points of the further tracking request match to the stored data points of at least two of the plurality of received tracking requests, the at least two received tracking requests including the first tracking request, wherein the determining, by matching the first URL received in the first tracking request and the stored first URL, includes scanning stored URLs associated with the at least two requests to identify the first URL.

21. (canceled)

22. A computer program product comprising computer program code stored on a computer readable storage medium, which, when executed by a processing means, causes the following steps to be performed:
receiving at a server means a first request from a user device, the request including a first uniform resource locator (URL), and storing the first URL;
receiving a second request from the user device, including a second URL and the first URL;
determining, by matching the first URL received in the second request and the stored first URL, that the first request and the second request were sent from the user device;
storing the second URL, so that a third request including the second URL can be matched using the stored second URL.

23. (canceled)

24. Apparatus comprising:
a processing means; and
a memory means having a computer program stored thereon, wherein the computer program comprises computer program code, wherein the processing means, together with the memory means and the computer program code, are configured to cause the following method to be performed:
receiving at a server means a first request from a user device, the request including a first uniform resource locator (URL), and storing the first URL;
receiving a second request from the user device, including a second URL and the first URL;
determining, by matching the first information and the stored first URL, that the first request and the second request were sent from the user device;
storing the second URL, so that a third request including the second URL can be matched the stored second URL.

25. (canceled)
